(19) United States
(12) Patent Application Publication
(10) Pub. No.: US 2026/0084902 A1
(43) Pub. Date: Mar. 26, 2026

(54) TILTING DEVICE AND METHOD FOR TILTING PACKAGES

(71) Applicant: KNAPP SYSTEMINTEGRATION GMBH, Leoben (AT)

(72) Inventors: Günther KAINERSDORFER, Graz (AT); Franz-Alois RIEDNER, Weisskirchen (AT)

(73) Assignee: KNAPP SYSTEMINTEGRATION GMBH, Leoben (AT)

(21) Appl. No.: 19/140,207

(22) PCT Filed: Apr. 10, 2024
(86) PCT No.: PCT/EP2024/059704

§ 371 Date: Jun. 17, 2025

(30) Foreign Application Priority Data
May 5, 2023 (EP) 23171838.8

(51) Int. Cl. B65G 47/24; B65G 21/12; B65G 61/00

(52) U.S. Cl. CPC B65G 47/24; B65G 21/12; B65G 61/00

(57) ABSTRACT

A tilting device for a conveying system in a picking facility and method for tilting packages. Packages, conveyed from a conveying inlet to a conveying outlet, are tiltable. The tilting device includes an inlet and outlet, a first limb connected to the inlet and outlet, and a second limb connected to the outlet. The limbs include conveying drives actuatable independently of one another to convey packages along a conveying direction, and tilting drives actuatable independently of one another to pivot the limbs about a pivot axis. The pivot axis is oriented crosswise to the conveying direction so a package conveyed onto the tilting device via the inlet can, depending on its orientation, be ejected without a change in orientation, or can be tilted from the first limb onto the second limb by actuation of the tilting drives to be ejected.

The invention relates to a tilting device for a conveying system, in particular a conveying system of a picking facility, which conveying system comprises a conveying inlet and a conveying outlet, wherein packages can be conveyed from the conveying inlet to the conveying outlet and can be tilted between the conveying inlet and conveying outlet.

The invention furthermore relates to a method for tilting one or more packages, in particular in a conveying system, in which conveying system an orientation of the packages is determined and the package is conveyed into a tilting device via an inlet.

From WO 2018/153717 A2, it is known that, in the case of conveying systems for picking packages, an orientation section can be provided on which the packages are oriented via actuators and/or manipulators in order to achieve a highest possible packing density during picking.

Furthermore, it follows from the prior art that, in conveying systems, tilting devices can also be used to orient the packages in order to be able to pick said packages with a high packing density, A tilting device of this type is known from US 2022/0112037 A1, for example. In this case, packages are transported to the tilting device and reoriented depending on the orientation thereof. However, this tilting device necessitates not only a determination of an orientation and of a size of the packages, but also a separating of the packages that are to be oriented. Typically, both the separating of the packages that are to be oriented and the conveying of the packages into the tilting device take place via a robot arm. Said robot arm places the packages that are to be oriented on a region of the tilting device before the tilting devices tilts the package and reorients it accordingly. An ejection of the oriented package can take place either directly via the tilting device or the robot arm. In conveying systems with tilting devices of this type, the disadvantage thus arises that said devices must be designed in a constructionally elaborate manner in order to be able to tilt packages depending on the orientation. In addition, a high time cost and, consequently, a low efficiency result with tilting devices of this type.

Accordingly, the object of the invention is the specification of a tilting device of the type named at the outset with which a package can be conveyed and tilted in an efficient manner depending on the orientation thereof.

Furthermore, an object of the invention is to specify a method of the type named at the outset with which packages can be easily and efficiently picked in a space-saving manner.

According to the invention, the first object is attained in that, in the case of the tilting device of the type named at the outset, it is provided that the tilting device comprises an inlet and at least one outlet, wherein a first limb, which is connected to the inlet and the outlet, and a second limb, which is connected to the outlet, are provided and the limbs comprise conveying drives that can be actuated independently of one another, with which one or more packages can be conveyed along a conveying direction, and tilting drives that can be actuated independently of one another, via which the limbs can be pivoted about at least one pivot axis, wherein the at least one pivot axis is preferably oriented essentially parallel to the conveying direction so that a package conveyed onto the tilting device via the inlet can, depending on the orientation of said package, either be ejected via the outlet by a first conveying drive of the first limb without a change in orientation, or can be tilted from the first limb onto the second limb by an actuation of the tilting drives, after which the package with a changed orientation can be ejected along the conveying direction via the outlet by a second conveying drive of the second limb. As a result, packages can be conveyed into the tilting device via the inlet independently of the orientation thereof. Since only the first limb is connected to the inlet, the package is received by said limb during or after being conveyed into the tilting device, wherein the package preferably rests on the first conveying drive with a first surface. Depending on the orientation of the package, said package can either be conveyed to the outlet along the conveying direction by an actuation of the first conveying drive, or can be tilted by a pivoting of the two limbs. It is thereby immaterial whether the second limb is pivoted first and then the first limb or the two limbs are pivoted jointly about the pivot axis. After the tilting, the package rests on the second limb with a changed orientation, that is, preferably with a second surface, and can be ejected along the conveying direction via the outlet by the second conveying drive. Here, conveying apparatuses are considered to be any apparatuses with which a conveying of packages that are resting on the limbs is enabled along the conveying direction.

To tilt the package, the two limbs are mounted on at least one pivot axis, wherein a separate pivot axis can be provided for each of the two limbs.

There preferably results, both during the conveying-in of the package, possibly by an actuation of the first conveying drive, and during the ejection of the package, by an actuation of the first and/or second conveying drive, a horizontally oriented conveying direction. Depending on a pivot movement of the limbs, it is also conceivable that, during the ejection of the package along the conveying direction, both limbs are aligned horizontally with the conveying direction, so that a new package can already be received by the first limb. This results in a particularly high efficiency of the tilting device.

It is expedient if the first and the second limb respectively have a length and a width of 0.3 m to 4 m in a top view. Typically, a length and width are at right angles to one another so that they enclose a plane. Preferably, the first and the second limb have the same length, whereby a tilting device can be used in a particuarly universal manner, in particular in the most diverse conveying systems. Usually, the limbs are embodied with an equal width, but in individual cases they can also be embodied with a different width. Typically, packages can be conveyed along a longitudinal axis of the limbs via the conveying drives so that the longitudinal axis and conveying direction thus preferably coincide.

The two limbs can comprise a limit, preferably embodied as a plate, at an end in order to prevent a falling of the package off of the limb.

It is preferably provided that the first conveying drive and/or the second conveying drive is embodied as a roller conveyor and/or belt conveyor, in particular with a modular belt. Packages can thus be conveyed into the tilting device and ejected therefrom in an equally simple, quick, and gentle manner. In the case of an embodiment as a roller conveyor, it can be advantageous if only a portion of the rollers are designed such they can be driven and the remaining rollers are passive.

Although a separate pivot axis can be provided for each of the two limbs in order to be able to pivot the two limbs independently of one another and to carry out the tilting of the package, it is nevertheless preferred if the first limb and the second limb are arranged on a shared, horizontal pivot axis. This namely results not only in a tilting device that is constructionally particularly simple, but also especially low-maintenance. In a top view of the tilting device, the pivot axis is preferably arranged between the two limbs and extends in a horizontal direction along the longitudinal axes thereof. Thus, the pivot axis preferably runs parallel to the conveying device.

For the purpose of actuating the conveying drives, each of the limbs preferably comprises at least one motor having a gear mechanism and a connecting means, in particular a geared motor with a belt drive. This results in conveying drives with which packages can be conveyed along the conveying direction particularly rapidly and efficiently. During actuation of the conveying drive, the motor drives the connecting means via the gear mechanism, so that packages located on the limb can be conveyed, in particular to the outlet of the tilting device.

Alternatively or additionally, it can also be provided that the conveying drives are embodied as motorized rollers and comprise a belt and/or a modular belt.

Expediently, the tilting drives are embodied as a motor with a gear mechanism, in particular a servomotor with a crank gear. As a result, the limbs can be pivoted in a constructionally simple and, at the same time, precise manner. Here, each motor is typically connected to one of the two limbs via a gear mechanism. Between the gear mechanism and limb, a set of rods can also be provided in order to be able to arrange and fasten the motor and gear mechanism such that they are spaced apart from the limb. Preferably, each of the limbs can also be provided with a supporting structure which is connected to the tilting drive via the set of rods and on which the conveying drive and the limit are arranged.

In a preferred from of the tilting device, the first limb and the second limb can be arranged at a right angle to one another in order to enable a particularly stable and efficient tilting of packages.

The tilting device according to the invention is preferably used in a conveying system, in particular of a picking facility, having an apparatus for determining an orientation of a package, in particular a camera or a laser sensor, a conveying inlet for conveying the package into the inlet of the tilting device, via which the package can be tilted, and a conveying outlet for ejecting the package from the outlet of the tilting device. This makes it possible to differentiate packages, the orientation of which should be changed on the conveying section, for example in order to achieve a beneficial picking with a high packing density, from packages, the orientation of which does not need to be changed, so that, depending on the necessary change in orientation, packages can be conveyed through the tilting device without a change or the orientation of the packages can be changed in the tilting device. In addition to a high packing density, a preferred packing layout can also be obtained by such a change in orientation of the packages.

Typically, all packages are conveyed from the conveying inlet of the conveying system to the inlet of the tilting device, so that a separate transport of packages that are to be oriented can be dispensed with. Accordingly, a differentiation of the packages conveyed from the conveying inlet to the conveying outlet in the conveying system into packages that are to be oriented and packages that are not to be oriented only plays an insignificant role, at least for a conveying distance and a conveying time of the packages. Packages are fed into the conveying system from a source via the conveying inlet. The conveying of the packages from the conveying inlet to the inlet of the tilting device typically takes place via a first roller conveyor. Expediently, the apparatus is arranged along the first roller conveyor or on or in the tilting device. For the ejection of packages that are not to be oriented and packages with a changed orientation, a second roller conveyor is arranged between the outlet of the tilting device and the conveying outlet. Apart from this, first and second roller conveyors can also, at least in some regions, be embodied as belt conveyors.

If the package is a package that is to be oriented, said package is tilted by a pivoting of the two limbs of the tilting device. The package then rests on the second limb of the tilting device and is conveyed to the outlet by the second conveying drive. The package is subsequently ejected via the conveying outlet by the second roller conveyor. Usually, the dimensions, in particular the widths, of the first and of the second roller conveyor differ, at least in some regions. This can typically be attributed to the fact that the second roller conveyor can be embodied with a larger width in the region of the outlet of the tilting device in order to be able to accept packages from both limbs. Alternatively, it can be possible to eject packages with a changed orientation to the conveying outlet from the outlet of the second limb via a separate roller conveyor, wherein the second and separate roller conveyors can, at least in some regions, be kept parallel and/or together.

If the package is a package that is not to be oriented, said package is conveyed to the outlet directly from the first limb by an actuation of the first conveying drive and is then conveyed to the conveying outlet by the second roller conveyor. Accordingly, the first limb is able to be used again particularly quickly for tilting packages that are to be oriented.

According to the invention, the method-related object is attained by a method of the type named at the outset in which the package is first received by a first limb of the tilting device, wherein depending on the orientation, the package is either ejected via an outlet along a conveying direction by a first conveying drive of the first limb or tilted by the tilting device in that, to tilt the package, the first limb and a second limb of the tilting device are pivoted about a pivot axis which is preferably essentially parallel to the conveying direction, so that a package that is to be oriented is received by the second limb and ejected via the outlet along the conveying direction by a second conveying drive of the second limb.

Typically, the method is carried out using a device according to the invention. Accordingly, there results a particularly efficient conveying of the package. Expediently, all packages thereby pass through the tilting device and are tilted depending on the orientation, wherein packages that are not to be oriented can be ejected in a simple and rapid manner by the first limb. For this purpose, the first limb is provided with the first conveying drive, in the actuation of which the package conveyed in from the inlet can be ejected via the outlet. A pivoting of the limbs is not necessary to do so.

However, if said package is a package that is to be oriented, and which is to be tilted, pivoting of the two limbs of the tilting device is imperative. The package is thereby conveyed into the tilting device via the inlet and received by the first limb before the package is tilted by the pivoting of the two limbs about the pivot axis, which is preferably parallel to the conveying direction, and received by the second limb. The package, with a changed orientation, is then ejected via the outlet by an actuation of the second conveying drive.

Preferably, the package is received by the first limb in a home position and the two limbs are jointly pivoted from the home position into an end position for the purpose of tilting the package. This results in a particularly efficient tilting of the package.

Due to the ability of the two limbs to pivot independently, both the home position and the end position can be freely defined to the greatest possible extent and can therefore be easily adapted to dimensions of the packages or to a field of application. Expediently, the first limb is arranged in the home position such that an essentially horizontal conveying direction results, whereby the package can be received in a particularly simple manner. Likewise, a horizontal conveying direction can result from the end position of the second limb, whereby the ejection of the package with a changed orientation is simplified.

Typically, the angle between the first limb and the second limb is maintained during the pivoting from the home position into the end position, wherein the angle in the home position is preferably 90%. Due to the ability of the two limbs to pivot independently, it is also possible. however, that the pivoting of the two limbs begins jointly, but that the first limb already reaches the end position after a pivot movement of less than 90°.

In principle, it would also be possible that the two limbs are jointly pivoted back into the home position.

However, it has proven effective if the first limb is pivoted back first into the home position from the end position and then the second limb. In this manner, the first limb can reach the home position more quickly and a new package can be received. This type of a return pivot of the limbs is particularly advantageous if the angle between the two limbs in the end position is greater than 90°, that is, the first limb is pivoted from the home position into the end position by an angle of less than 90°.

An improved efficiency of the method results in particular if the first limb is pivoted back into the home position even before the ejection of the package with a changed orientation. Thus, in the meantime, the first limb can, in the home position, receive at least one new package and eject it via the first conveying drive while the second conveying drive is being actuated in order to eject the package with a changed orientation from the tilting device along the conveying direction via the outlet. Preferably, the second limb is pivoted back into the home position directly after the ejection of the package. Once said limb reaches the home position, the next package can, provided a package that is to be oriented was received in the meantime from the first conveying drive, already be tilted.

Advantageously, the second limb is pivoted 90° from the home position into the end position. Thus, not only do packages that are to be oriented and have been received by the first limb rest on the second limb particularly soon and are able to be tilted especially gently, said packages can also be ejected particularly quickly by the second conveying drive.

Preferably, the first limb is pivoted less than 90°, but more than 45°, from the home position into the end position. The first limb can thus be pivoted back into the home position particularly quickly, in order to receive at least one new package, It is beneficial if the first limb is pivoted more than 45° in order to be able to securely tilt all packages, regardless of the centers of gravity thereof.

Typically, the package with a changed orientation is ejected by the second conveying drive in the end position. This provides the advantage that the first limb can, in the meantime, already be pivoted back into the home position, whereby a particularly high efficiency of the method results.

Preferably, the first limb and the second limb are pivoted about the same pivot axis independently of one another. This allows, in a constructionally simple manner, a precise pivoting of the two limbs.

Additional features, advantages, and effects invention follow from the exemplary embodiments described below. In the drawings which are thereby referenced:

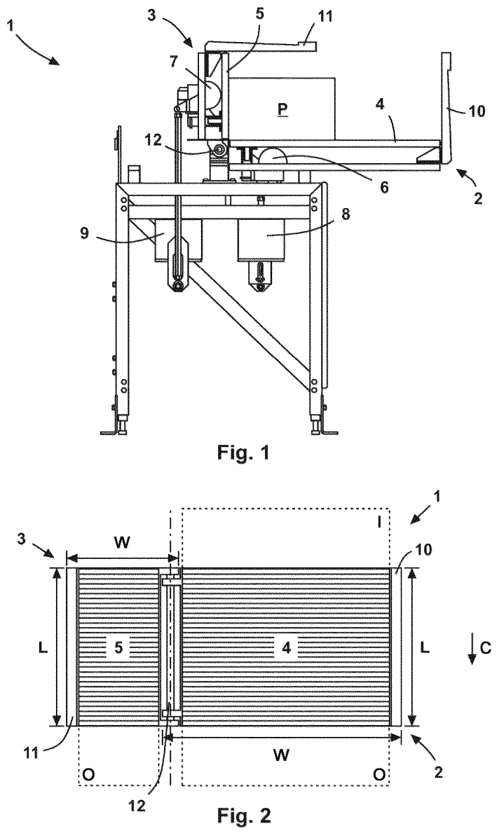

FIG. 1 shows a front view of an exemplary embodiment of a tilting device;

FIG. 2 shows a top view of the tilting device from FIG. 1 with pivoted limbs;

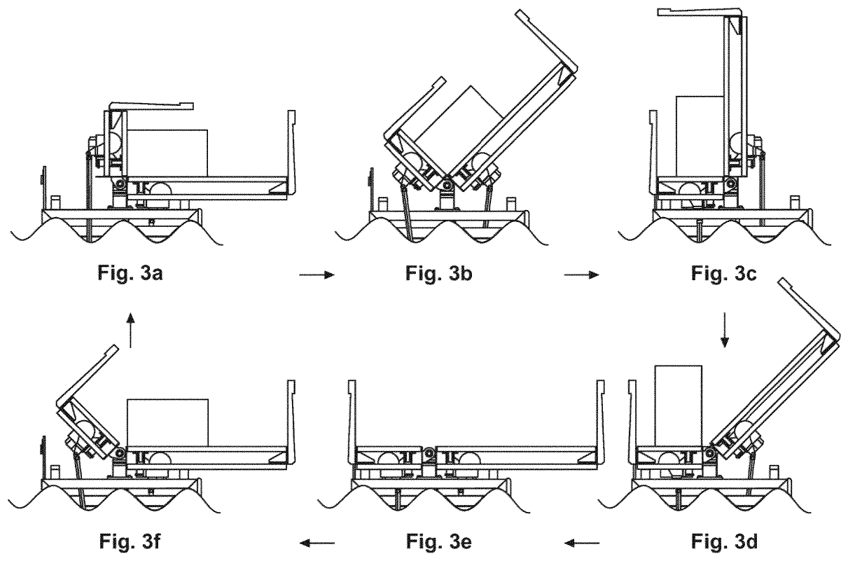

FIGS. 3a through f shpw front views of the tilting device from FIG. 1 with limbs pivoted differently;

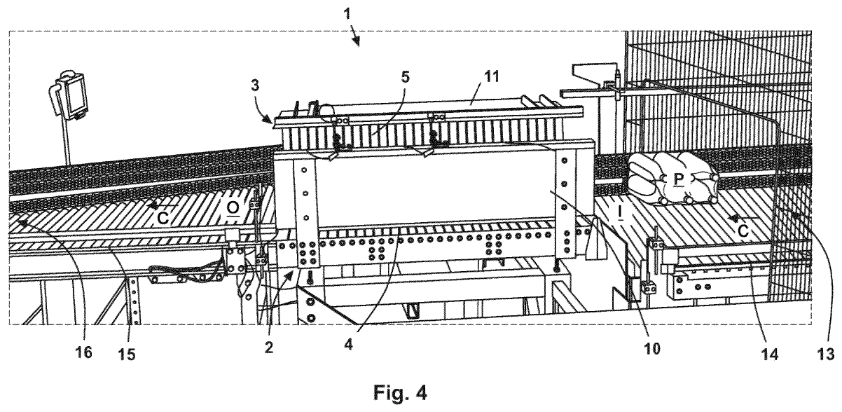

FIG. 4 shows a perspective view of the tilting device in a conveying system;

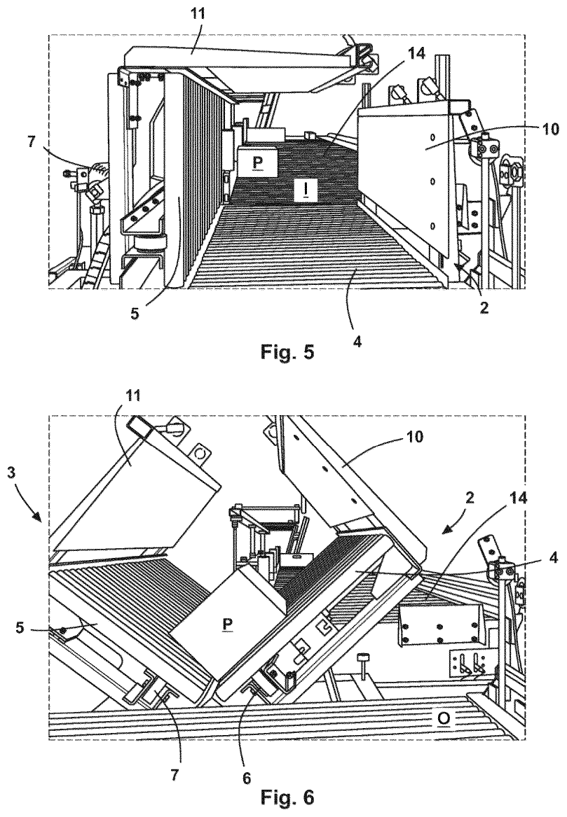

FIG. 5 shows a perspective view of the tilting device from FIG. 3 in a home position;

FIG. 6 shows a perspective view of the tilting device from FIG. 3 during pivoting into an end position;

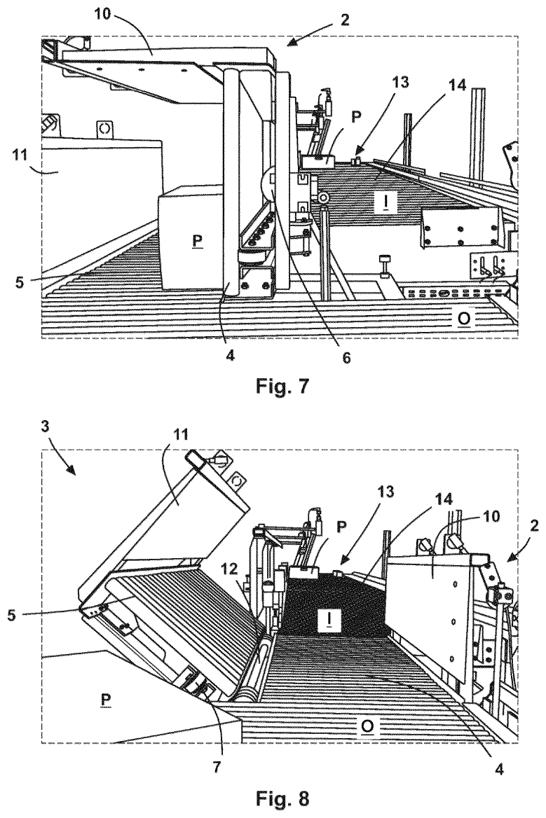

FIG. 7 shows a perspective view of the tilting device from FIG. 3 in the end position;

FIG. 8 shows a perspective view of the tilting device from FIG. 3 during pivoting into the home position.

The exemplary embodiment of a tilting device 1 illustrated in FIG. 1 comprises two limbs 2, 3 and is depicted in a front view with a viewing direction along a conveying direction C. The limbs 2, 3 shown both respectively comprise a conveying drive 4, 5 for conveying packages P, which conveying drives 4, 5 are embodied as roller conveyors in this exemplary embodiment. For the actuation of the conveying drives 4, 5, said conveying drives 4,5 respectively comprise a motor having a gear mechanism, specifically a geared motor 6, 7 with a belt drive. In addition, both limbs 2, 3 are respectively connected to a tilting drive 8, 9 which in this case are embodied as servomotors with a crank gear, and are connected to one of the limbs 2, 3 via one set of rods each, whereby the limbs 2, 3 can be pivoted independently of one another. Furthermore, both limbs 2, 3 respectively comprise at outer ends a limit 10, 11 embodied as a plate, by which limit 10, 11 a falling of the package P off of the limbs 2, 3 is prevented.

From the top view of FIG. 2, in which a position of the limbs 2, 3 differs from that from FIG. 1, it is evident that the limbs 2, 3 of the tilting device 1 shown have different widths W but an equal length L, wherein the second limb 3 is embodied with a smaller width W than the first limb 2. In this illustration, an inlet I, via which packages P can be conveyed onto the first limb 2, and outlets O, via which packages P can be ejected by an actuation of the conveying drives 4, 5, are indicated by dashed lines. In addition, the conveying direction C is illustrated in the form of an arrow, which in the specific exemplary embodiment constitutes a straight-line, horizontal connection between the inlet I and outlet O. Apart from this, the theoretical pivot axis that runs centrally through a pivot axis 12 and parallel to the conveying direction C, is drawn as a dash-dotted line.

Additionally, from the top view from FIG. 2 in combination with the front view from FIG. 1, it becomes particularly clear that, to receive the package P, a first limb 2 is arranged parallel to the essentially horizontal conveying direction C. The package P is thereby conveyed into the tilting device 1 via the inlet 1 along the conveying direction C, wherein the inlet I is connected to the first limb 2 so that the package P can be received by the first limb 2 and, in said position, by the first conveying drive 4. If the package P is a package that is not to be oriented, the first conveying drive 4 is actuated and the package P is conveyed directly to the outlet O of the tilting device 1 in the conveying direction C, which outlet O is likewise connected to the first limb 2 of the tilting device 1. Accordingly, the package P is conveyed along the conveying direction C and passes through the tilting device 1 without being tilted.

By contrast, a package P that is to be oriented is received by the first limb 2 and tilted by a pivoting of both limbs 2, 3 about a horizontal pivot axis 12. This is achieved by a corresponding actuation of the tilting drives 8, 9. Due to the shaping of the package P, said package P is tilted from a first surface onto an adjacent second surface.

For the purpose of tilting the package P, a home position shown in FIG. 1 has proven effective, in which home position the two limbs 2, 3 are positioned at a right angle to one another. In addition, the two limbs 2, 3 are preferably pivoted about a shared, horizontal pivot axis 12 which, as can be seen from FIG. 2, is arranged between the two limbs 2, 3. A preferred sequence of the tilting using the tilting device 1 of this exemplary embodiment is shown in FIG. 3a through fand is explained in greater detail in the following.

In FIG. 3a through f, different stages of tilting are shown with the aid of the exemplary embodiment of the tilting device 1 from FIG. 1. FIG. 3a shows the home position of the tilting device 1 previously illustrated in FIG. 1, in which the first limb 2 and the second limb 3 are positioned at a right angle to one another, the package P has already been conveyed into the tilting device I from the inlet 1 along the conveying direction C and has been received by the first limb 2 and conveying drive 4. Due to the angle of the two limbs 2, 3 to one another and the shaping of the package P, said package P rests with a first surface on the first conveying drive 4 and, at the same time, already rests with a second surface against the second limb 3 and conveying drive 5. However, a surface contact with the limbs 2, 3 and conveying drives 4, 5 may, depending on the shaping of the package P, also not be necessary. In FIG. 3b, a first intermediate position is shown in which, by an actuation of the tilting drives 8, 9 for the purpose of tilting the package P, the two limbs 2, 3 are first jointly pivoted and deflected 45° from the home position. Both surfaces of the package P thereby rest on the conveying drives 4, 5 of both limbs 2, 3. Through further joint pivoting of the limbs 2, 3, an end position shown in FIG. 3c is reached. In the end position, the second limb 3 is arranged horizontally, whereby the package P is, via the second surface thereof, received with a changed orientation by the second limb 3, and is ejected in the conveying direction C by an actuation of the second conveying drive 5. Accordingly, not only is the first limb 2 connected to the outlet O, but also the second limb 3. This ejection takes place during the stages of tilting shown in FIGS. 3c through 3e, wherein the first limb 2 is already pivoted back into the home position independently of the second limb 3 between FIGS. 3c and 3d. Said return pivot can be particularly clearly recognized in FIG. 3d, in which the first limb 2 is already deflected 45° from the end position thereof.

In FIG. 3e, the first limb 2 has already fully arrived in the home position and is horizontally arranged, so that said limb 2 can already receive a new package P and, if it is a package that is not to be oriented, can directly eject said package P via the outlet O in the conveying direction C by an actuation of the first conveying drive 4. However, if it is a package P that is to be oriented, said package P is merely received by the first limb 2 and conveying drive 4. In this stage of tilting, the dimensions of the limbs 2, 3 and the orientation of the pivot axis 12 are especially easy to recognize, as is also illustrated in FIG. 2.

As shown in FIG. 3f, the second limb 3 is also pivoted back into the home position after an actuation of the second conveying drive 5 and the ejection of the package P with a changed orientation. In this illustration, the second limb 3 has already pivoted halfway back into the home position, which corresponds to a deflection of 45° from the horizontal end position of the second limb 3. As can be seen in FIG. 3a, the package P received by the first limb 2 and conveying drive 4 can be tilted as soon as the second limb 3 reaches the home position. The stages of tilting from FIGS. 3a through f are then run through again in order to also be able to tilt the new package P.

FIG. 4 illustrates a perspective view of a tilting device I integrated into a conveying system. A package P depicted as a beverage package is thereby conveyed from a conveying inlet 13 to the inlet I of the tilting device 1 via a first roller conveyor 14. The tilting device 1 is embodied essentially analogously to the exemplary embodiment of the tilting device 1 from FIG. 1.

Typically, the orientation of the package P on the first roller conveyor 14 is already known, or is determined using an apparatus with an optical sensor, in particular a camera or a laser sensor, arranged along the first roller conveyor 14. Alternatively, the apparatus can also be arranged on the tilting device 1.

Packages P that are to be oriented, which are conveyed into the tilting device I via the inlet I and received by the first limb 2 and conveying drive 4, are tilted as described in the foregoing and ejected via the outlet O of the tilting device 1 by an actuation of the second conveying drive 5. The package P with a changed orientation is thereby received by a second roller conveyor 15 and conveyed by said conveyor to a conveying outlet 16. Similar to the limits 10, 11 of the two limbs 2, 3, the first roller conveyor 14 and the second roller conveyor 15 of the conveying system also comprise stops through which an orientation of the packages P that are to be conveyed along the conveying device C can be maintained to the greatest possible extent and the falling of the packages P off of the roller conveyors 14, 15 can be prevented. Furthermore, the second roller conveyor 15 has a larger width than the first roller conveyor 14 in order to be able to receive all packages P from the outlet O of the tilting device 1, that is, both packages P with a changed orientation ejected by the second limb 3 and packages P that are not to be oriented and are ejected by the first limb 2.

As a result of the tilting of packages P that are to be oriented and the direct ejection of packages P that are not to be oriented from the tilting device 1, it is ensured that all packages P are appropriately oriented, in order to be able to achieve a preferred packing layout and a particularly high packing density during a picking of the packages P.

In FIG. 5, the tilting device |integrated into the conveying system is illustrated from the view of the outlet O. The limbs 2, 3 of the tilting device I are thereby arranged in the previously described home position and the dimensions thereof are easily recognized. Furthermore, on the first roller conveyor 14, the package P is visible which is conveyed from the conveying inlet 13 to the inlet I of the tilting device 1 and rests against the stop. The first roller conveyor 14 transitions seamlessly into the first limb 2 of the tilting device I so that the package P can be received particularly easily by the first limb 2.

FIG. 6 shows the tilting device 1 integrated into the conveying system, from the same perspective. In contrast to FIG. 5, the limbs 2, 3 are jointly pivoted approx. 45° to the home position, so that essentially the stage of tilting shown in FIG. 3b is depicted. Here, the geared motors 6, 7, in particular the belt drives thereof, and conveying drives 4, 5 are recognizable. Likewise, the outlet O of the tilting device I and a portion of the second roller conveyor 15 can be recognized, via which the package P with a changed orientation can be ejected from the tilting device 1 and conveyed to the conveying outlet 16.

In FIG. 7, the tilting device I shows in the end position in the same perspective. The package P with a changed orientation has thereby been received by the second limb 3 and conveying drive 5, but still rests against the first limb 2 and conveying drive 4. The illustrated end position corresponds to the end position of the tilting device 1 shown in FIG. 3c. The tilting is thereby complete and the package P with a changed orientation can be ejected via the outlet O by an actuation of the second conveying drive 5. The package P with a changed orientation is then conveyed by the second roller conveyor 15 to the conveying outlet 16. A new package P is already conveyed to the inlet I on the first roller conveyor 14.

In FIG. 8, the tilting device 1 is shown in the same perspective, wherein the first limb 2 is already fully pivoted back into the home position. In the tilting device 1 shown, as also illustrated in FIG. 3a through f, first the first limb 2 and, only after an ejection of the package P with a changed orientation, the second limb 3 are pivoted back into the home position. Here, the pivot axis 12 on which the limbs 2, 3 are arranged can be recognized. In this specific case, the return pivot of the second limb 3 is not yet complete; rather, said limb 3 is pivoted 45° out of the end position. This corresponds, to the greatest possible extent, to the arrangement of the limbs 2, 3 as is shown in FIG. 3f.

The package P with a changed orientation was already ejected via the outlet O of the tilting device 1 by an actuation of the second conveying drive 5 and is conveyed on the second roller conveyor 15 in the direction of the conveying outlet 16. In the event that a package P that is not to be oriented is conveyed into the inlet I of the tilting device 1 via the first roller conveyor 14 and reaches the first limb 2, said package P could still be ejected via the outlet O of the tilting device 1 by an actuation of the first conveying drive 4 before the second limb 3 reaches the home position. Accordingly, it would also be possible to convey said package P that is not to be oriented directly to the second roller conveyor 15 and onward to the conveying outlet 16.

With the tilting device 1 according to the invention, packages P can be tilted about an axis oriented horizontally and essentially parallel to a conveying direction C depending on the orientation of said packages P, so that a particularly high packing density results during the picking of the packages P.

1. A tilting device for a conveying system, in particular a conveying system of a picking facility, which conveying system comprises a conveying inlet and a conveying outlet wherein packages can be conveyed from the conveying inlet to the conveying outlet and can be tilted between the conveying inlet and conveying outlet, wherein the tilting device comprises an inlet and at least one outlet wherein a first limb which is connected to the inlet and the outlet, and a second limb which is connected to the outlet are provided and the limbs comprise conveying drives that can be actuated independently of one another, with which one or more packages an be conveyed along a conveying direction and tilting drives that can be actuated independently of one another, via which the limbs can be pivoted about at least one pivot axis wherein the at least one pivot axis is preferably oriented essentially parallel to the conveying direction so that a package conveyed onto the tilting device via the inlet can, depending on the orientation of said package either be ejected via the outlet by a first conveying drive of the first limb without a change in orientation, or can be tilted from the first limb onto the second limb by an actuation of the tilting drives after which the package with a changed orientation can be ejected along the conveying direction via the outlet by a second conveying drive of the second limb.

2. The tilting device according to claim 1, wherein the pivot axis is oriented essentially parallel to the conveying direction.

3. The tilting device according to claim 1, wherein the first conveying drive and/or the second conveying drive is embodied as a roller conveyor and/or belt conveyor, in particular with a modular belt.

4. The tilting device according to claim 1, wherein the first limb and the second limb are arranged on a shared, horizontal pivot axis.

5. The tilting device according to claim 1, wherein, for the purpose of actuating the conveying drives each of the limbs comprises at least one motor having a gear mechanism and a connecting means, in particular a geared motor with a belt drive, driven rollers, and/or a modular belt.

6. The tilting device according to claim 1, wherein the tilting drives are embodied as a motor with a gear mechanism, in particular a servomotor with a crank gear.

7. The tilting device according to claim 1, wherein the first limb and the second limb can be arranged at a right angle to one another.

8. A conveying system, in particular of a picking facility, having an apparatus for determining an orientation of a package in particular a camera or a laser sensor, a conveying inlet for conveying the package into the inlet of a tilting device according to claim 1, via which the package can be tilted, and a conveying outlet for ejecting the package from the outlet of the tilting device.

9. The conveying system according to claim 8, wherein the conveying system comprises the tilting device wherein the conveying inlet is connected to the inlet and wherein the conveying outlet is connected to the outlet.

10. A method for tilting one or more packages, in particular using a tilting device according to claim 1, in particular in a conveying system, in which conveying system an orientation of the package is determined and the package is conveyed into a tilting device via an inlet, wherein the package is first received by a first limb of the tilting device wherein depending on the orientation, the package is either ejected via an outlet along a conveying direction by a first conveying drive of the first limb or tilted by the tilting device in that, to tilt the package the first limb and a second limb of the tilting device are pivoted about a pivot axis which is preferably essentially parallel to the conveying direction so that a package that is to be oriented is received by the second limb and ejected via the outlet along the conveying direction by a second conveying drive of the second limb.

11. The method according to claim 10, wherein the package is received by the first limb in a home position and the two limbs are jointly pivoted from the home position into an end position for the purpose of tilting the package.

12. The method according to claim 10, wherein the first limb is pivoted back first into the home position from the end position and then the second limb.

13. The method according to claim 10, wherein the first limb is pivoted back into the home position even before the ejection of the package with a changed orientation.

14. The method according to claim 10, wherein the second limb is pivoted 90° from the home position into the end position.

15. The method according to claim 10, wherein the first limb is pivoted less than 90°, but more than 45°, from the home position into the end position.

16. The method according to claim 10, wherein the package with a changed orientation is ejected by the second conveying drive in the end position.

17. The method according to claim 10, wherein the first limb and the second limb are pivoted independently of one another about the same pivot axis.
